(19) United States
(12) Patent Application Publication
(10) Pub. No.: US 2024/0112086 A1
(43) Pub. Date: Apr. 4, 2024

(54) AUTOMATICALLY LINKING DIGITAL CALENDAR EVENTS TO ACTIVITIES

(71) Applicant: Vivun Inc., Oakland, CA (US)

(72) Inventor: Rayne Hernandez, San Francisco, CA (US)

(21) Appl. No.: 18/474,891

(22) Filed: Sep. 26, 2023

Related U.S. Application Data
(60) Provisional application No. 63/410,311, filed on Sep. 27, 2022.

(51) Int. Cl. G06N 20/00; G06Q 10/1093

(52) U.S. Cl. CPC G06N 20/00; G06Q 10/1095

(57) ABSTRACT

A computer-implemented method executed using a first computer and comprising transmitting one or more database queries to a database to cause executing searches that return result sets of one or more first calendar events, one or more linked second calendar events that are associated in a database with one or more activities, and one or more user account records that specify associations of user accounts to the one or more activities; processing one or more of the first calendar events to extract organization-independent features, yielding one or more processed calendar events; evaluating each of the one or more processed calendar events using a trained machine learning classifier to output a prediction of whether each of the one or more processed calendar events represents an internal event of an entity, and classifying the one or more processed calendar events having prediction values less than a threshold prediction value as activity events; executing a transformer-based machine learning model to embed the activity events as target vectors and to embed a corpus based on the first calendar events and user account records as candidate vectors; executing a similarity search of the target vectors against the candidate vectors to output a set of linking candidate vector values that most likely correspond to a particular activity that is represented in the corpus; ranking the set of linking candidate vector values to form a set of ranked candidate vector values; transmitting, to a second computer, presentation instructions that are programmed to cause the second computer to display one or more of the activity events that correspond to the ranked candidate vector values in a graphical user interface.

### BENEFIT CLAIM

This application claims the benefit of provisional application 63/410,311, filed Sep. 27, 2022, the entire contents of which are hereby incorporated by reference for all purposes as if fully set forth herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright or rights whatsoever. © 2022 Vivun Inc.

### TECHNICAL FIELD

One technical field of the present disclosure is computer-implemented machine learning systems including Bayesian classifiers, Transformer-based models, and gradient boosting, especially as applied to recommender systems. Another technical field is multiuser, multitenant, hosted application servers that support management of projects and calendars.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Computer-supported project management is widely used in a variety of domains. Projects can arise in the evaluation of complex software systems, software development, construction, engineering, education, financial services, legal services, and virtually every other domain of industry. Projects can be termed activities.

At the same time, computer-supported calendar management has become widespread. Digital electronic calendars are available in desktop computer client applications as well as hosted online systems that are accessed using a client computer with a browser to connect, over a data network, to a networked application server. In such hosted systems, the electronic calendar can be integrated into a larger application. In either context, the systems enable creating, updating, and deleting calendar events, representing meetings, calls, or other occurrences, for a single date and time or for a multi-day period. Furthermore, calendar events often represent important data to understand the progress and status of an activity or project. However, calendar events typically cannot be linked to projects or activities, at least not without a lot of work. Manual action using multiple human-computer interactions typically are required to associate a calendar event with an activity, and the resulting association may be loose or awkward. An example is cutting and pasting a copy of the content of a calendar event into a text box of a project management system. While this captures the data of the calendar event, it is inefficient and does not provide a persistent link between the two systems.

Consequently, manually linking calendar events to a relevant activity or project is tedious and an unpleasant part of the user experience. Rules-based systems could be used to predict activities associated with a given event, but rules-based systems are not particularly accurate. Therefore, there is an acute need in the foregoing technical fields for improved automatic, computer-implemented methods to digitally link calendar events to activities or projects.

### SUMMARY

The appended claims may serve as a summary of the invention.

### BRIEF DESCRIPTION OF THE DRAWINGS

In the drawings:

FIG. 1A illustrates a distributed computer system showing the context of use and principal functional elements with which one embodiment could be implemented.

FIG. 1B illustrates principal functional elements of the calendar linking logic of FIG. 1A, in one embodiment.

FIG. 2A illustrates an algorithm or programmable process flow to implement one embodiment of a method of automatically linking digital calendar events to activities.

FIG. 2B illustrates an algorithm or programmable process flow to implement another embodiment of a method of automatically linking digital calendar events to activities.

FIG. 3 illustrates a computer display device having rendered an example graphical user interface having a table of calendar events in which some events are not associated with an activity.

FIG. 4 illustrates a portion of the graphical user interface of FIG. 3 additionally comprising a panel showing a plurality of suggested activities to associate with a calendar event and in which one suggested activity has been selected.

FIG. 5 illustrates a portion of the graphical user interface of FIG. 3 additionally comprising a graphical calendar display that includes at least one calendar event that is not associated with an activity and a plurality of calendar events that are associated with activities.

FIG. 6 illustrates the graphical user interface of FIG. 5 in which a calendar event has been selected that is associated with an activity and a plurality of suggestions of associations to potentially change the association have been generated and displayed.

FIG. 7 illustrates a computer system with which one embodiment could be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

The text of this disclosure, in combination with the drawing figures, is intended to state in prose the algorithms that are necessary to program a computer to implement the claimed inventions, at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement the inventions claimed herein.

Embodiments are described in sections below according to the following outline:
1. General Overview
2. Structural & Functional Overview
   2.1 Distributed Computer System Implementation
   2.2 Example Process Implementations
   2.3 Example User Interface Implementations
3. Implementation Example—Hardware Overview

1. General Overview

In general, embodiments provide a machine learning system that helps predict and associate a relevant activity to a given calendar event. By automatically associating calendar events to relevant activities, embodiments provide several practical results. First, the efficiency of using computers is increased because less manual work is required to associated events. Users can create calendar events without taking any action to associate the events with activities, as the associations are created automatically. Consequently, entity reporting burdens are reduced. Second, embodiments support vastly improved technical forecasting and analytics because the associations of multiple calendar events to an activity can comprise input data to calculate or estimate how much time users are spending on a particular activity, and how that time is spent.

Various embodiments of the disclosure encompass the subject matter of the following numbered clauses:

1. A computer-implemented method executed using a first computer and comprising: transmitting one or more database queries to a database to cause executing searches that return result sets of one or more first calendar events, one or more linked second calendar events that are associated in a database with one or more activities, and one or more user account records that specify associations of user accounts to the one or more activities; processing one or more of the first calendar events to extract organization-independent features, yielding one or more processed calendar events; evaluating each of the one or more processed calendar events using a trained machine learning classifier to output a prediction of whether each of the one or more processed calendar events represents an internal event of an entity, and classifying the one or more processed calendar events having prediction values less than a threshold prediction value as activity events; executing a transformer-based machine learning model to embed the activity events as target vectors and to embed a corpus based on the first calendar events and user account records as candidate vectors; executing a similarity search of the target vectors against the candidate vectors to output a set of linking candidate vector values that most likely correspond to a particular activity that is represented in the corpus; ranking the set of linking candidate vector values to form a set of ranked candidate vector values; transmitting, to a second computer, presentation instructions that are programmed to cause the second computer to display one or more of the activity events that correspond to the ranked candidate vector values in a graphical user interface.

2. The method of clause 1, further comprising evaluating each of the one or more processed calendar events using a trained naïve Bayes machine learning classifier to output the prediction of whether each of the one or more processed calendar events represents the internal event of an entity, and classifying the one or more processed calendar events having prediction values less than a threshold prediction value as activity events.

3. The method of clause 1, further comprising executing a Sentence-BERT transformer-based machine learning model to embed the activity events as the target vectors and to embed the corpus based on the first calendar events and the user account records as the candidate vectors.

4. The method of clause 1, further comprising executing the similarity search as a nearest neighbor search of the target vectors against the candidate vectors to output the set of linking candidate vector values.

5. The method of clause 1, further comprising ranking the set of linking candidate vector values to form a set of ranked candidate vector values by executing a gradient boosted tree algorithm.

6. The method of clause 1, further comprising evaluating each of the one or more processed calendar events using the trained machine learning classifier, having been trained using a training dataset of other calendar events, the other calendar events that are not linked to the activities having been labeled as internal events, to output a prediction of whether each of the one or more processed calendar events represents an internal event of an entity, and classifying the one or more processed calendar events having prediction values less than a threshold prediction value as activity events.

7. The method of clause 1, further comprising receiving, from the second computer, input signaling a selection of a particular activity event from among the one or more of the activity events in the graphical user interface, and in response to the input, creating and storing in the database an association of the particular activity event to the particular activity.

8. The method of clause 1, further comprising: transmitting, to the second computer, presentation instructions that are programmed to cause the second computer to display an electronic calendar graphical user interface comprising a list of a plurality of the calendar events that are not associated with the one or more activities; receiving, from the second computer, first input signaling a selection in the list of a particular calendar event; transmitting, to the second computer, presentation instructions that are programmed to cause the second computer to display a graphical panel specifying one or more of the activity events that correspond to the ranked candidate vector values.

9. The method of claim 8, further comprising: receiving, from the second computer, second input signaling a selection of a particular activity event from among the one or more of the activity events in the graphical panel; in response to the second input, creating and storing in the database an association of the particular activity event to the particular activity.

10. The method of claim 1, further comprising: transmitting, to the second computer, presentation instructions that are programmed to cause the second computer to display an electronic calendar graphical user interface comprising at least one first graphical panel associated with a calendar date and a time of day and specifying one the calendar events that is not associated with the one or more activities; receiving, from the second computer, first input signaling a selection of a particular first graphical panel; transmitting, to the second computer, presentation instructions that are programmed to cause the second computer to display a second graphical panel specifying one or more of the activity events that correspond to the ranked candidate vector values.

11. The method of claim 10, further comprising: receiving, from the second computer, second input signaling a selection of a particular activity event from among the one or more of the activity events in the second graphical panel; in response to the second input, creating and storing in the database an association of the particular activity event to the particular activity.

2. Structural & Functional Overview

2.1 Distributed Computer System Implementation

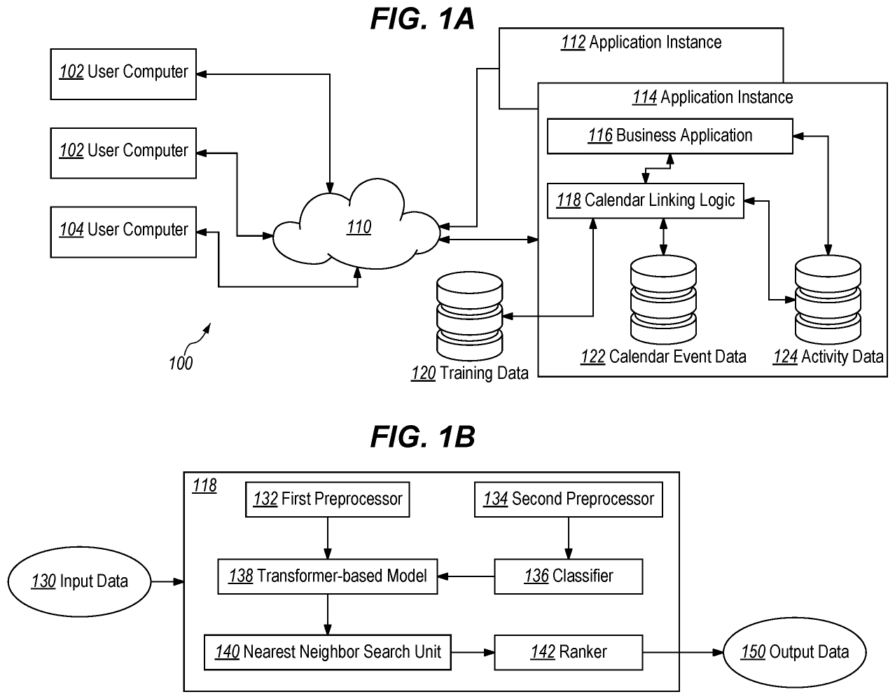

FIG. 1A illustrates a distributed computer system showing the context of use and principal functional elements with which one embodiment could be implemented. In an embodiment, a computer system comprises components that are implemented at least partially by hardware at one or more computing devices, such as one or more hardware processors executing stored program instructions stored in one or more memories for performing the functions that are described herein. In other words, all functions described herein are intended to indicate operations that are performed using programming in a special-purpose computer or general-purpose computer, in various embodiments. FIG. 1A illustrates only one of many possible arrangements of components configured to execute the programming described herein. Other arrangements may include fewer or different components, and the division of work between the components may vary depending on the arrangement.

FIG. 1A, and the other drawing figures and all of the description and claims in this disclosure, are intended to present, disclose and claim a technical system and technical methods in which specially programmed computers, using a special-purpose distributed computer system design, execute functions that have not been available before to provide a practical application of computing technology to the problem of machine learning model development, validation, and deployment. In this manner, the disclosure presents a technical solution to a technical problem, and any interpretation of the disclosure or claims to cover any judicial exception to patent eligibility, such as an abstract idea, mental process, method of organizing human activity or mathematical algorithm, has no support in this disclosure and is erroneous.

In the example of FIG. 1A, one or more user computers 102, 104 are communicatively coupled via network 110 to one of a plurality of application instances 112, 114, thus forming a distributed computing system. Each of the user computers 102, 104 may comprise any kind of computing device such as a desktop computer, laptop computer, tablet computer, mobile computing device, or workstation. Each of the user computers 102, 104 broadly represent any computing device that any person or entity uses to request, receive, and render pages, documents, or files to interact with application instances 112, 114; the term “user” is used for convenience and other labels can be used in other embodiments, such as client, customer, visitor, etc. For clarity, FIG. 1A shows three (3) user computers 102, 104, the system can include thousands to millions of visitor computers depending upon the processing capacity of application instances 112, 114.

In an embodiment, the user computers 102, 104 act as client devices in relation to application instances 112, 114, which function as servers. In one embodiment, the application instances 112, 114 are programmed to generate and transmit presentation instructions to the user computers 102, 104 in response to requests that the user computers transmit to the application instances. In this embodiment, each of the user computers 102, 104 executes application programs including a browser. The browser can comprise any application program that is compatible with open protocols such as HTTP and HTML; commercially available examples include CHROME, SAFARI, and EDGE.

Network 110 broadly represents any combination of one or more local area networks, wide area networks, campus networks, and internetworks, using any of terrestrial or satellite links, wired or wireless links. Network 110 provides digital electronic telecommunication between the user computers 102, 104 and application instances 112, 114, using open protocols such as IP, TCP, HTTP.

Each of the application instances 112, 114 represents a set of executable program instructions hosted on and executed using a computing device. In various embodiments, the computing device can comprise any computing device that is capable of responding to requests from and providing services to a large number of end station devices like the user computers 102, 104. In various embodiments, the server computer can comprise any of a single-machine processor, multi-processor machine, a processor or machine cluster, and/or one or more virtual computing instances in any of public datacenters and private datacenters. The application instances 112, 114 can execute using public online third-party cloud computing datacenters or services such as AMAZON WEB SERVICES, MICROSOFT AZURE, and similar services to execute back-end services relating to call management, facilitating connections, data storage, analytics, and similar functions. The application instances 112, 114 can be associated with a merchant, service provider, or any other person or entity that user computers 102, 104 could need to visit or interact with.

In an embodiment, the application instances 112, 114 can form parts of a multi-tenant, multi-user application server system in which user computers 102 are associated with a first entity or tenant and the user computer 104 is associated with a second, different entity or tenant. Each of the application instances 112, 114 can be configured in a similar form and execute the same instructions but interoperate with a different set of user computers 102, 104 as authorized clients via API keys, session keys, session identifiers, or other security controls. Each of the application instances 112, 114 can integrate, or be communicatively coupled to, a web server comprising an HTTP protocol server that can respond to requests of the user computers 102, 104. The server computer and/or the application instances 112, 114 can include a firewall, load balancer, or other infrastructure to manage large numbers of requests.

Each of the application instances 112, 114 comprises a business application 116 and calendar linking logic 118 and is communicatively coupled to one or more digitally stored datasets such as training data 120, calendar event data 122, and activity data 124. The business application 116 can implement any useful program application for the user computers 102, 104, such as a presales application, engineering project management application, merchant or store application, or an application that provides substantive services in any industry or field of use, including but not limited to financial applications, education applications, government applications, agricultural applications, or others.

The training data 120, calendar event data 122, and activity data 124 can be digitally stored using one or more relational databases, flat file systems, object data stores, no-SQL data repositories, or other digital data storage. Training data 120 comprises one or more datasets that can be used to train machine learning elements of the calendar linking logic; in one embodiment, the training data comprises a copy of all calendar events that are then currently stored in calendar event data 122 for all calendars associated with all user accounts, across all tenants. Calendar event data 122 comprises a data repository to support calendar functionality that the business application 116 provides, or a separate calendar application, and consists of a plurality of individual event records or items each representing a meeting, call, occurrence, act, or other event. The term “calendar event” in this disclosure can refer to one such record or item. Activity data 124 comprises a data repository to store tables with records of projects or activities.

Each record of an activity can comprise, refer to, or contain, digital data for an opportunity, deliverable, activity, or other element of a project that the business application 116 manages and/or supports creating, reading, updating, or deleting. In the specific context of presales management, an activity can be any of an opportunity, deliverable, and activity. In some embodiments in this context, each calendar event comprises a row in a database table that associates event information such as a name, date, and time, an account, an opportunity, a deliverable, and an activity, each of which is stored as a column value or attribute of the row. Other embodiments may have more or fewer columns or attributes.

A server computer or cloud computing instance that hosts or executes the application instances 112, 114 further comprises random-access, volatile main memory to store all or part of the executable program instructions for the business application 116 and calendar linking logic 118. In some embodiments, the calendar linking logic instantiates and interoperates with digitally stored data values and data structures that are hosted in main memory of the server computer; examples include candidate vectors, matrices of candidate vectors, and hash maps, as further described in other sections herein. In other embodiments, if the foregoing structures will not fit in main memory based on dataset size, then sharding or approximate search techniques can be used to effectively swap portions of the dataset into memory or execute the techniques herein on a portion of the data.

FIG. 1B illustrates principal functional elements of the calendar linking logic of FIG. 1A, in one embodiment. The calendar linking logic 118 may comprise a first preprocessor 132 and a second preprocessor 134, which are programmed to execute preprocessing transformations of different kinds on different datasets within input data 130, as further described herein in other sections. The second preprocessor 134 is programmatically coupled to a classifier 136, which can be implemented as a machine learning classifier. The first preprocessor 132 and the classifier 136 are programmatically coupled to a transformer-based machine learning model 138, which is programmatically coupled to a nearest neighbor search unit 140. Output of the nearest neighbor search unit 140 is programmatically coupled to ranker 142, which outputs a set of output data 150.

Each of the first preprocessor 132, second preprocessor 134, classifier 136, transformer-based machine learning model 138, can comprise a set of executable program instructions that are programmed as described herein in other sections. In one embodiment, all of the first preprocessor 132, second preprocessor 134, classifier 136, transformer-based machine learning model 138 can be linked as a single application, method, service, or microservice.

2.2 Example Process Implementations

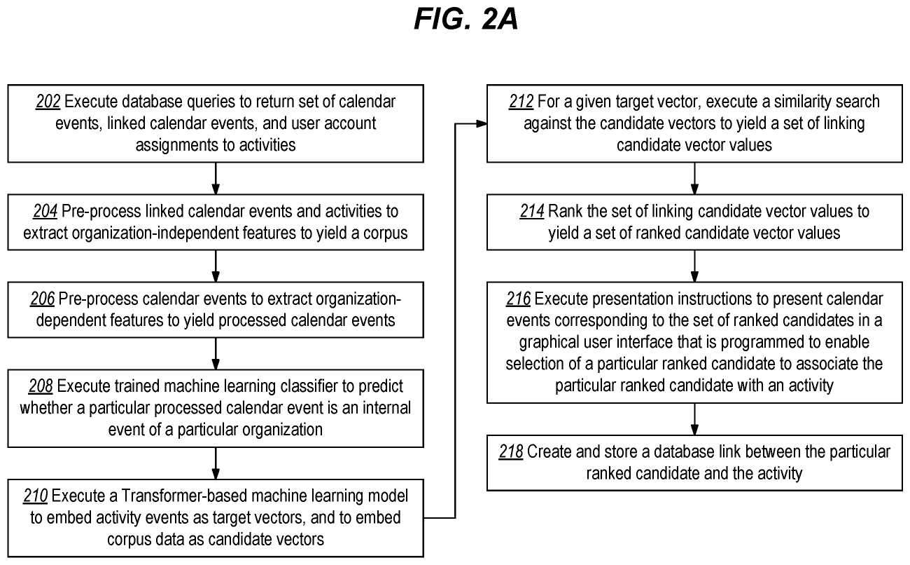

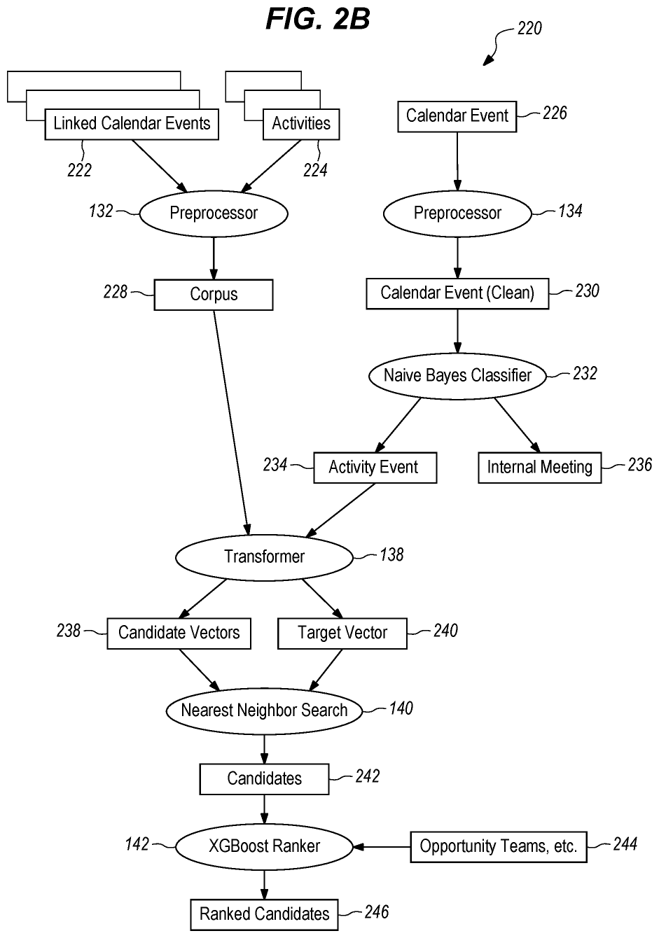

FIG. 2A illustrates an algorithm or programmable process flow to implement one embodiment of a method of automatically linking digital calendar events to activities. FIG. 2B illustrates an algorithm or programmable process flow to implement another embodiment of a method of automatically linking digital calendar events to activities. FIG. 2A, FIG. 2B, and each other flow diagram herein is intended as an illustration at the functional level at which skilled persons, in the art to which this disclosure pertains, communicate with one another to describe and implement algorithms using programming. The flow diagrams are not intended to illustrate every instruction, method object or sub-step that would be needed to program every aspect of a working program, but are provided at the same functional level of illustration that is normally used at the high level of skill in this art to communicate the basis of developing working programs.

The problems outlined in the Background of this disclosure are solved using the embodiments shown in the drawing figures and described herein based on considering the relevant technical as a recommender system (RecSys) task. For any given calendar event that a user creates, the systems of FIG. 1A, FIG. 1B and the algorithms of FIG. 2A, 2B are arranged to generate a candidate pool of possible opportunities and activities associated with the event and to rank the candidates based on relevance to the possible opportunities and activities. First, the calendar linking logic 118 is programmed to determine whether a particular calendar event is associated with an opportunity, or is an internal event of a particular entity, for example, a weekly one-on-one meeting between a manager and her reports. Next, the calendar linking logic 118 is programmed to create a candidate pool from a list of possible activities that are associated with an organization of a user account that created the calendar event. Finally, the calendar linking logic 118 is programmed to rank the candidates based on their features, such as a similarity of the descriptions of the activities to text in the calendar event, or whether the user account is associated with a group or team in the entity that is associated with the predicted activity.

Referring first to FIG. 2A, one embodiment of the calendar linking logic 118 is programmed at block 202 to execute one or more database queries to return a set of calendar events, linked calendar events, and user account assignments to activities. The set of calendar events includes items that user accounts have created and that are not linked to activities that the business application 116 manages. The set of linked calendar events includes items that user events have created and that are already linked to activities. The set of user account assignments to activities comprises rows of a table that the business application 116 manages in a database schema of activity data 124 and that associate each user account of all users to zero or more activities.

At block 204, the calendar linking logic 118 is programmed to pre-process the linked calendar events and activities to extract organization-independent features to yield a digitally stored corpus. Pre-processing at block 204 adds features to the corpus that do not require tenant-specific, entity-specific, or organization-specific parameters. Examples of pre-processing at block 204 include extracting features from text in the linked calendar events, such as event attendees and event duration. The result is a full corpus of candidate events for consideration in later processing steps.

At block 206, the calendar linking logic 118 is programmed to pre-process calendar events to extract organization-dependent features to yield processed calendar events. Block 206 can comprise using a preprocessor that has been configured or trained for each organization, entity, or tenant. Examples of organization-dependent values include the internal email domain that an organization uses. By preprocessing calendar events to extract organization-dependent features, the features can be used to derive other values that can inform event classification, such as what percent of the attendees or invitees identified in a calendar event are internal participants.

At block 208, the calendar linking logic 118 is programmed to execute a trained machine learning classifier to predict whether a particular processed event is an internal event of a particular organization. For example, to determine if a meeting is relevant to an activity, a classifier can be trained on a dataset of training data 120 that is labeled to identify internal meetings or calendar events and other meetings or calendar events that are associated with activities. Our classifier uses the event text and percentage of internal attendees as features. Output of block 208 is a set of activity events.

At block 210, the calendar linking logic 118 is programmed to execute a transformer-based machine learning model to embed, as target vectors, the activity events that were output from classification at block 208, and to embed, as candidate vectors, the corpus data. In an embodiment, to yield an effective list of candidate activities for target event, an embedding space is created for all terms associated with an organization; each term is digitally stored and represented as a numerical vector. A transformer-based model such as Sentence-BERT (SBERT) can be used for the embeddings, with pre-trained models that capture the semantic meaning of several sentences of text. In an embodiment, the candidate vectors can be digitally stored in a matrix data structure. In some embodiments that interoperate with relatively small datasets, the matrix data structures in main memory of a computing instance that is hosting application instance 114. A hash map can link each vector of the matrix to a corresponding set of activity primary keys in activity data 124. Examples of primary keys include account_id and opportunity_id.

In an embodiment, at block 212, the calendar linking logic 118 is programmed to execute a similarity search for a given target vector against the candidate vectors to yield a set of linking candidate vector values. Using a matrix facilitates fast execution of a similarity search for a given vector. Similarity searches can be performed for all vectors. Therefore, for a given event, the algorithm results in outputting a smaller pool of candidate vector values for possible linking from among all possible matches.

At block 214, the calendar linking logic 118 is programmed to rank the linking candidates to yield a set of ranked candidates. In an embodiment, a machine learning model is trained using a gradient-boosted trees approach such as XGBoost to rank the candidates. Features of effective training data can comprise the distance between the target and candidate in vector space, and whether the user account that created the target belongs to an opportunity team associated with the candidate. Block 214 also can be programmed to query, in activity data 124, the activities that are associated with the highest ranked nearest neighbors from the hash map; the result set from such a query forms a final output dataset, for programmatic communication to another system, method, or service, or for presentation in a user interface or other human-computer output.

At block 216, the calendar linking logic 118 is programmed to execute presentation instructions to present calendar events corresponding to the accounts and activities that are associated with the highest ranked nearest neighbors. Presentation can be in a graphical user interface that is programmed to enable selection of a particular ranked candidate to associate that particular ranked candidate with an activity. Examples of graphical user interfaces are described in section 2.3.

At block 216, the calendar linking logic 118 is programmed to create and store a database link between the particular ranked candidate and the activity. In one embodiment, block 216 comprises updating a calendar event record in a table of calendar event data 122 to insert a row identifier, or other unique identifier, of the activity in a column or attribute of the calendar event record. Additionally or alternatively, block 216 can comprise updating an activity record in activity data 124 to insert a row identifier, or other unique identifier, of the calendar event in a column or attribute of the activity record. Or, both links can be created in both records. The specific mechanics of creating a data association are not critical if a calendar event is associated, in digitally stored data of some kind, with an activity.

Referring now to FIG. 2B, a more detailed view of an example algorithm or programmed process 220 is shown, with indications of how a calendar event passes through the machine learning models of FIG. 1A, FIG. 1B. Initial inputs to process 220 comprise linked calendar events 222, activities 224, and a calendar event 226. The initial inputs can be obtained, in an embodiment, by programmed steps to:
1. Query the calendar event data 122 to return a set of calendar events by organization, entity, or tenant. In the case of a duplicate event_id, use the most recent data for each event_id.
2. Query a calendar_event_activity table in the calendar event data 122 or activity data 124 that links a calendar event_id to an activity_id. In response, join the calendar data to the associated activity.
3. Query opportunity_team_member tables in the activity data 124. The result set can be used in subsequent steps, such as determining whether the invitees or attendees identified in a calendar event are associated with a given opportunity.

The linked calendar events 222 and activities 224 are transmitted programmatically to a first preprocessor 132. The calendar event 226 is transmitted programmatically to a second preprocessor 134. The first preprocessor 132 adds features that require no organization-specific parameters, so that the same preprocessor code can be used for any organization. Features such as event attendees and event duration can be extracted. The output of linked activities passed through the first preprocessor 132 is a corpus 228 of candidates. The second preprocessor 134 is trained for each organization, entity, or tenant on organization-specific features and outputs a processed event 230, which is programmatically transmitted to a classifier 232. In this context, “programmatically transmitted” can mean programmatically called, invoked using an API, called using a remote procedure call, returned as a method result, or other program-implemented means of communicating data between code at runtime.

In an embodiment, the classifier 232 comprises a naïve Bayes classifier. In one implementation, training data for the classifier 232 is derived from all calendar events in calendar event data 122, including those that are not linked to activities. All calendar events that are not linked to activities are labeled as internal events. Labeling can be manual or automatic; for example, heuristics can be programmed to label certain calendar events as internal events, for example, when an account_id field is provided in the calendar event but has a null value. All other linked calendar events are labeled as activity-associated events.

The calendar event text is encoded using the Term Frequency Inverse Document Frequency (TF-IDF) of records technique, to focus on certain terms being associated with internal meetings rather than semantic sentence meaning. An example of a term in a calendar event that could specify an internal meeting is “weekly sync”. A Naïve Bayes classifier then is trained to predict whether a given event is internal or not, given the set of features including word embeddings and event data such as the percentage of participants with an internal email domain identifier. Output of classifier 232 comprises a prediction value, which can be compared to a threshold value to determine whether to output the particular event as an activity event 234 or an internal meeting 236. The threshold value can be a hard-coded constant in the calendar linking logic 118 or can be a configuration value stored in a file.

The corpus 228 and activity event 234 are programmatically transmitted to a transformer-based machine learning model 138. In an embodiment, calendar linking logic 118 is programmed to use a pretrained SBERT model to embed documents as vectors. SBERT is a PYTHON library having documentation that is publicly available, at the time of this writing, at the domain SBERT.NET on the World Wide Web. With SBERT, the same model is used across organizations, which helps conserve memory. After evaluation via the transformer-based machine learning model 138, a particular calendar event has a target vector, and therefore the model produces candidate vectors 238 and target vector 240 as output, which are programmatically transmitted to nearest neighbor search unit 140.

In an embodiment, the nearest neighbor search unit 140 is programmed to execute a similarity search against the matrix of candidate vectors using cosine similarity. Candidate vector values can be sorted by cosine similarity to the target vector, to return the top K candidate vector values 242. The value K can be hard coded as a candidate_pool_size constant or stored in a configuration file; an example value is 30 and embodiments can use any value K in the range 10 to 100 or more. Each candidate vector then is mapped to associated activity information. In one embodiment in the presales context, associated activity information can be account_id and opportunity id.

Candidate vector values 242 are programmatically transmitted to the ranker 142, which outputs a set of ranked candidates 246. In an embodiment, ranker 142 is programmed with the goal to augment the similarity score produced by the nearest neighbor search unit 140 with additional features. Example additional features including opportunity teams data 244 which can specify, for example, whether an opportunity team member is in the attendee list of a calendar event represented by a candidate vector value, any attendees of the calendar event have been linked previously to a candidate's account. The ranker 142 can use XGBoost to train a machine learning model on a set of candidate vector values for a given even that have been labeled “good” and “bad” as candidates for association. As with the process of FIG. 2A, ranked candidates 246 can be programmatically transmitted to another method, system, service, or microservice, presented in a graphical user interface, or used in other processing.

In some embodiment, the processes of FIG. 2A, FIG. 2B are executed in an offline evaluation based on the subset of events that have been associated previously with activities. That event data can be divided into a training dataset and a test dataset by holding out a set of calendar events from the corpus to determine how the model classifies events that have not been processed before. Practical models will execute with reasonably high precision and recall @k={1, 3, 5, 10}; in an embodiment applied in the presales context, the foregoing are calculated separately for account, opportunity, deliverable, and activity. For example, evaluation can specify how often the model selects the correct account as the top prediction (k=1), the top three predictions (k=3), and the top five predictions (k=5). The k=1 metrics should be sufficiently high to support automatically labeling events without user intervention, but k={3, 5, 10} are useful to prove that the model is approximately correct in returning relevant results.

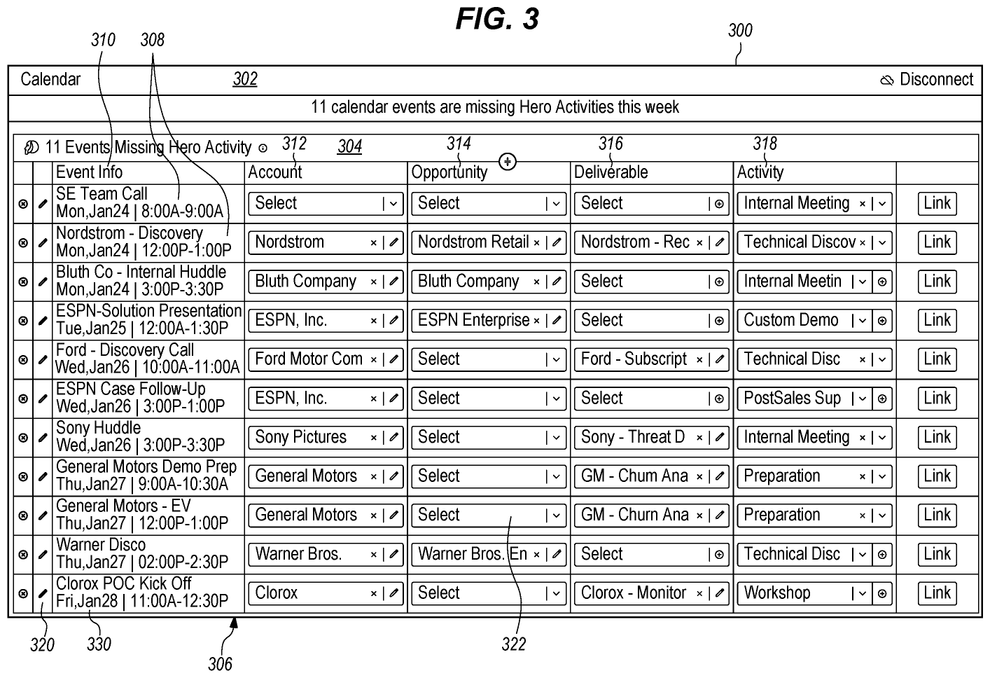

Using the implementations of this section and the preceding section, FIG. 1A, FIG. 1B, FIG. 2A, FIG. 2B, FIG. 3 and the accompanying descriptions thereof provide examples of how to make and use the subject matter of the following numbered clauses:

1. A computer-implemented method executed using a first computer and comprising: transmitting one or more database queries to a database to cause executing searches that return result sets of one or more first calendar events, one or more linked second calendar events that are associated in a database with one or more activities, and one or more user account records that specify associations of user accounts to the one or more activities; processing one or more of the first calendar events to extract organization-independent features, yielding one or more processed calendar events; evaluating each of the one or more processed calendar events using a trained machine learning classifier to output a prediction of whether each of the one or more processed calendar events represents an internal event of an entity, and classifying the one or more processed calendar events having prediction values less than a threshold prediction value as activity events; executing a transformer-based machine learning model to embed the activity events as target vectors and to embed a corpus based on the first calendar events and user account records as candidate vectors; executing a similarity search of the target vectors against the candidate vectors to output a set of linking candidate vector values that most likely correspond to a particular activity that is represented in the corpus; ranking the set of linking candidate vector values to form a set of ranked candidate vector values; transmitting, to a second computer, presentation instructions that are programmed to cause the second computer to display one or more of the activity events that correspond to the ranked candidate vector values in a graphical user interface.

2. The method of clause 1, further comprising evaluating each of the one or more processed calendar events using a trained naïve Bayes machine learning classifier to output the prediction of whether each of the one or more processed calendar events represents the internal event of an entity, and classifying the one or more processed calendar events having prediction values less than a threshold prediction value as activity events.

3. The method of clause 1, further comprising executing a Sentence-BERT transformer-based machine learning model to embed the activity events as the target vectors and to embed the corpus based on the first calendar events and the user account records as the candidate vectors.

4. The method of clause 1, further comprising executing the similarity search as a nearest neighbor search of the target vectors against the candidate vectors to output the set of linking candidate vector values.

5. The method of clause 1, further comprising ranking the set of linking candidate vector values to form a set of ranked candidate vector values by executing a gradient boosted tree algorithm.

6. The method of clause 1, further comprising evaluating each of the one or more processed calendar events using the trained machine learning classifier, having been trained using a training dataset of other calendar events, the other calendar events that are not linked to the activities having been labeled as internal events, to output a prediction of whether each of the one or more processed calendar events represents an internal event of an entity, and classifying the one or more processed calendar events having prediction values less than a threshold prediction value as activity events.

2.3 Example User Interface Implementations

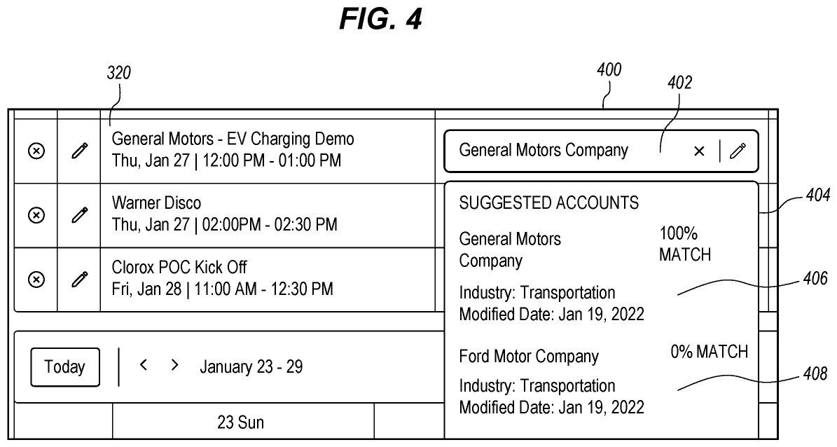

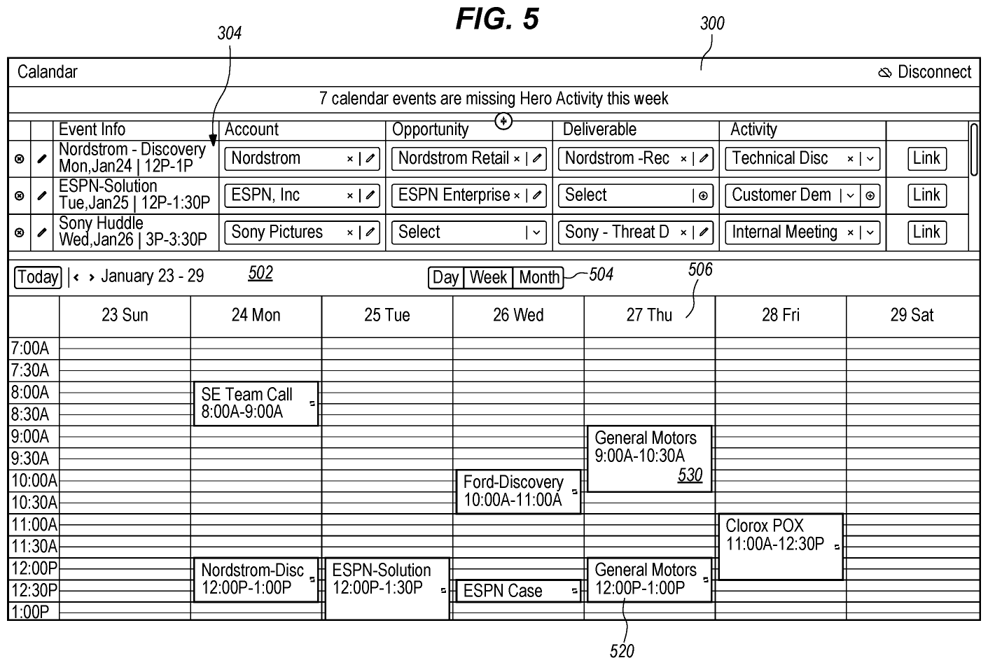

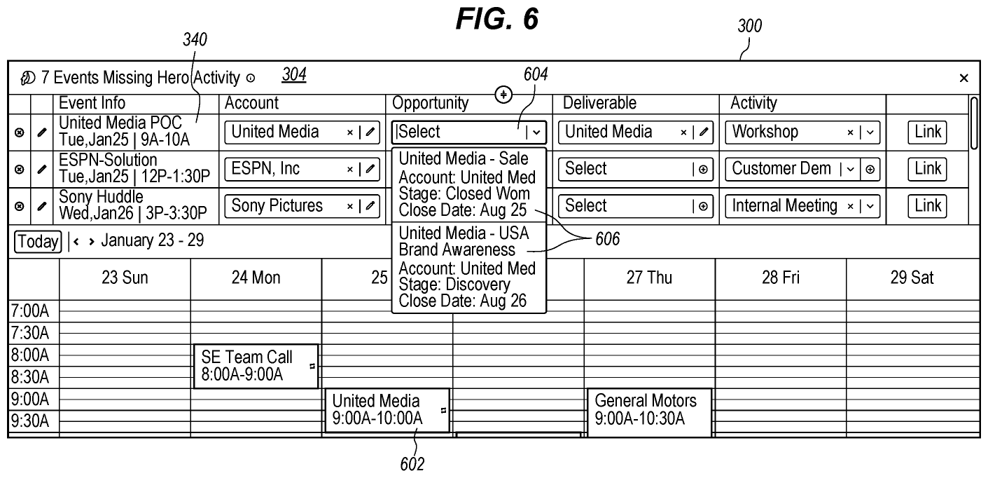

As described for the block of FIG. 2A showing internal meeting 236 and in relation to ranked candidates 246 of FIG. 2B, output candidate calendar events can be presented, in one embodiment, in graphical user interfaces that are programmed to receive input from a user computer to view the candidates and/or to associate one of the candidate calendar events with an activity. FIG. 3, FIG. 4, FIG. 5, FIG. 6 illustrate examples of one possible set of graphical user interfaces and GUI transformations that can be used. For purposes of illustrating clear examples, FIG. 3, FIG. 4, FIG. 5, FIG. 6 use labels, terminology and arrangements of display elements that are useful in the context of presales management of accounts, opportunities, deliverables, and activities. Other embodiments can be applied to other applications and can use different labels, terminology, and display elements to implement functionally equivalent processes with customization for those applications.

FIG. 3 illustrates a computer display device having rendered an example graphical user interface having a table of calendar events in which some events are not associated with an activity. In an embodiment, a computer display device 300 of user computer 102, 104 can receive presentation instructions which when rendered cause displaying a graphical user interface 306 that can be associated with a calendar application 302 and comprising an event list 304. In an embodiment, calendar application 302 displays event list 304 after executing a query to calendar event data 122 to return a set of calendar events that are missing one or more associations to activities. The set of calendar events in the event list 304 can be all calendar events that are missing associations, a subset for a particular day, range of days, or other period or range of periods. Business application 116 can be programmed to display the event list 304 completely, or with scroll bars to permit scrolling to other portions, or with a LOAD MORE link or the equivalent to signal a request to load other calendar events in the result set, for example using streaming query and data presentation techniques.

In one approach, event list 304 comprises a plurality of list rows 308. In the specific context of presales management, each of the list rows 308 can have an event information column heading 310, account column heading 312, opportunity column heading 314, deliverable column heading 316, and activity column heading 318 to indicate that, for the example of FIG. 3 in the presales context, each of the list rows 308 represents a record in calendar event data 122 that associates event information, an account, an opportunity, a deliverable, and an activity. For other applications or contexts, different column headings and attribute values can be used for list rows and the specific columns of FIG. 3 are not required. For some rows, one or more values are unspecified or null. For example, list row 320 has a null value for the opportunity attribute, as does list row 330.

Assume that a user computer 102 receives input via a pointing device or keyboard to select list row 320 or a column value of that row. In response, calendar linking logic 118 or business application 116 can be programmed execute the algorithm of FIG. 2A or FIG. 2B, and to generate and transmit presentation instructions which when rendered at the user computer 102 cause presenting a graphical panel that includes one or more calendar events corresponding to ranked calendar events that the algorithms output. FIG. 4 illustrates a portion of the graphical user interface of FIG. 3 additionally comprising a panel showing a plurality of suggested activities to associate with a calendar event and in which one suggested activity has been selected. In the example of FIG. 4, in response to input selecting list row 320, calendar linking logic 118 has generated and transmitted presentation instructions to display a graphical panel 404 comprising two suggested activities 406, 408, in the form of accounts. The graphical panel 404 can be programmed to include a widget 402 to select one of the suggested activities. In the example of FIG. 4, a first activity 406 is populated in widget 402. In an embodiment, input from user computer 102 to select the activity value shown in widget 402 causes calendar linking logic 118 to create and store, in calendar event data 122 and/or activity data 124, a link or association of the calendar event represented in list row 320 with the first suggested activity 406. Any of the approaches of block 216 of FIG. 2A can be used.

FIG. 5 illustrates a portion of the graphical user interface of FIG. 3 additionally comprising a graphical calendar display that includes at least one calendar event that is not associated with an activity and a plurality of calendar events that are associated with activities. In the example of FIG. 5, computer display device 300 has received presentation instructions that have been rendered to display the calendar event list 304 of FIG. 3. Further, the presentation instructions have specified rendering a graphical calendar panel 502 having a period control widget 504 and a plurality of calendar panels 506 that specify days, weeks, or months, depending on a setting of the period control widget.

Each of the calendar panels 506 can comprise zero or more event panels 520, 530 that represent calendar events from calendar event data 122. For example, event panels 520, 530 show calendar events that correspond to list rows 320, 330 of FIG. 3. A first event panel 520 indicates a calendar event that is associated with an activity. A second event panel 530 indicates a calendar event that is not associated with an activity. The event panels can be displayed with different colors, shading, highlighting, or other graphical attributes or image attributes to convey or suggest whether the event panels are associated with an activity or not.

FIG. 6 illustrates the graphical user interface of FIG. 5 in which a calendar event has been selected that is associated with an activity and a plurality of suggestions of associations to potentially change the association have been generated and displayed. For example, assume that a third event panel 602 has been selected via input from a user computer 102. In response, calendar linking logic 118 is programmed to automatically scroll or jump the event list 304 to display, at the top, a list row 340 corresponding to the selected third event panel, and existing data values or column attributes that are stored in calendar event data 122 for that event. In the example of FIG. 6, list row 340 has an undefined or null value for the opportunity attribute. The calendar linking logic 118 is programmed to generate presentation instructions which when rendered cause displaying a selection widget 604 over, at, or near the undefined or null value of the attribute and one or more suggested activities 606 that have been predicted as likely to be relevant to the calendar event of the list row 340. In an embodiment, input from user computer 102 to select a particular suggested activity from among the suggested activities 606 causes calendar linking logic 118 to update the interface to show the particular suggested activity as a value of the selection widget 604.

Additionally or alternatively, calendar linking logic 118 can be programmed to create, in response to the input from user computer 102 to select a particular suggested activity from among the suggested activities 606, an association or link of the calendar event of list row 340 and the third event panel 602 to the particular suggested activity, in one or more of calendar event data 122 and activity data 124. Any of the approaches of block 216 of FIG. 2A can be used.

Using the implementations of this section, FIG. 3, FIG. 4, FIG. 5, FIG. 6 and the accompanying descriptions thereof provide examples of how to make and use the subject matter of the following numbered clauses:

7. The method of clause 1, further comprising receiving, from the second computer, input signaling a selection of a particular activity event from among the one or more of the activity events in the graphical user interface, and in response to the input, creating and storing in the database an association of the particular activity event to the particular activity.

8. The method of clause 1, further comprising: transmitting, to the second computer, presentation instructions that are programmed to cause the second computer to display an electronic calendar graphical user interface comprising a list of a plurality of the calendar events that are not associated with the one or more activities; receiving, from the second computer, first input signaling a selection in the list of a particular calendar event; transmitting, to the second computer, presentation instructions that are programmed to cause the second computer to display a graphical panel specifying one or more of the activity events that correspond to the ranked candidate vector values.

9. The method of claim 8, further comprising: receiving, from the second computer, second input signaling a selection of a particular activity event from among the one or more of the activity events in the graphical panel; in response to the second input, creating and storing in the database an association of the particular activity event to the particular activity.

10. The method of claim 1, further comprising: transmitting, to the second computer, presentation instructions that are programmed to cause the second computer to display an electronic calendar graphical user interface comprising at least one first graphical panel associated with a calendar date and a time of day and specifying one the calendar events that is not associated with the one or more activities; receiving, from the second computer, first input signaling a selection of a particular first graphical panel; transmitting, to the second computer, presentation instructions that are programmed to cause the second computer to display a second graphical panel specifying one or more of the activity events that correspond to the ranked candidate vector values.

11. The method of claim 10, further comprising: receiving, from the second computer, second input signaling a selection of a particular activity event from among the one or more of the activity events in the second graphical panel; in response to the second input, creating and storing in the database an association of the particular activity event to the particular activity.

3. Implementation Example—Hardware Overview

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

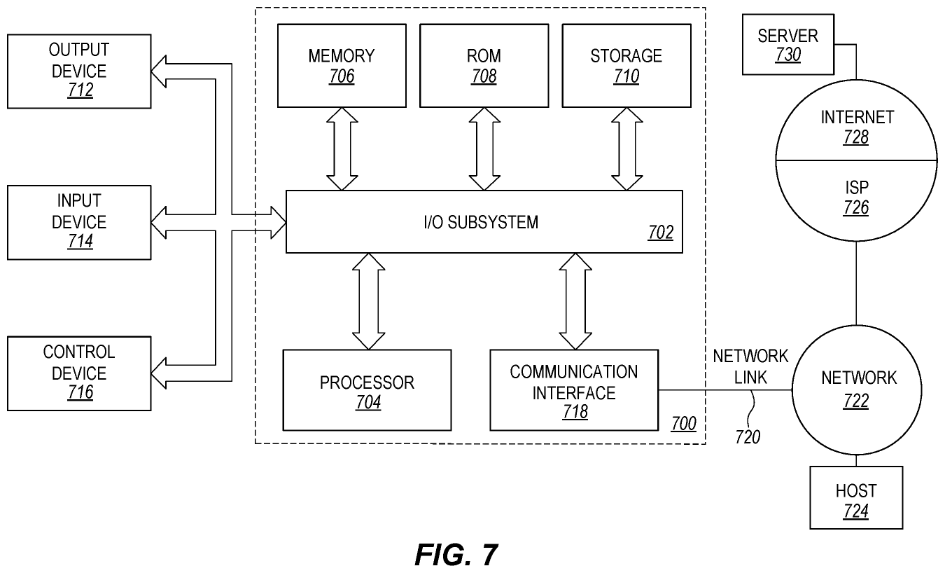

FIG. 7 is a block diagram that illustrates an example computer system with which an embodiment may be implemented. In the example of FIG. 7, a computer system 700 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 700 includes an input/output (I/O) subsystem 702 which may include a bus and/or other communication mechanism(s) for communicating information and/or instructions between the components of the computer system 700 over electronic signal paths. The I/O subsystem 702 may include an I/O controller, a memory controller and at least one I/O port. The electronic signal paths are represented schematically in the drawings, for example as lines, unidirectional arrows, or bidirectional arrows.

At least one hardware processor 704 is coupled to I/O subsystem 702 for processing information and instructions. Hardware processor 704 may include, for example, a general-purpose microprocessor or microcontroller and/or a special-purpose microprocessor such as an embedded system or a graphics processing unit (GPU) or a digital signal processor or ARM processor. Processor 704 may comprise an integrated arithmetic logic unit (ALU) or may be coupled to a separate ALU.

Computer system 700 includes one or more units of memory 706, such as a main memory, which is coupled to I/O subsystem 702 for electronically digitally storing data and instructions to be executed by processor 704. Memory 706 may include volatile memory such as various forms of random-access memory (RAM) or other dynamic storage device. Memory 706 also may be used for storing temporary variables or other intermediate information during execution of instructions to be executed by processor 704. Such instructions, when stored in non-transitory computer-readable storage media accessible to processor 704, can render computer system 700 into a special-purpose machine that is customized to perform the operations specified in the instructions.

Computer system 700 further includes non-volatile memory such as read only memory (ROM) 708 or other static storage device coupled to I/O subsystem 702 for storing information and instructions for processor 704. The ROM 708 may include various forms of programmable ROM (PROM) such as erasable PROM (EPROM) or electrically erasable PROM (EEPROM). A unit of persistent storage 710 may include various forms of non-volatile RAM (NVRAM), such as FLASH memory, or solid-state storage, magnetic disk or optical disk such as CD-ROM or DVD-ROM and may be coupled to I/O subsystem 702 for storing information and instructions. Storage 710 is an example of a non-transitory computer-readable medium that may be used to store instructions and data which when executed by the processor 704 cause performing computer-implemented methods to execute the techniques herein.

The instructions in memory 706, ROM 708 or storage 710 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 700 may be coupled via I/O subsystem 702 to at least one output device 712. In one embodiment, output device 712 is a digital computer display. Examples of a display that may be used in various embodiments include a touch screen display or a light-emitting diode (LED) display or a liquid crystal display (LCD) or an e-paper display. Computer system 700 may include other type(s) of output devices 712, alternatively or in addition to a display device. Examples of other output devices 712 include printers, ticket printers, plotters, projectors, sound cards or video cards, speakers, buzzers or piezoelectric devices or other audible devices, lamps or LED or LCD indicators, haptic devices, actuators or servos.

At least one input device 714 is coupled to I/O subsystem 702 for communicating signals, data, command selections or gestures to processor 704. Examples of input devices 714 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 716, which may perform cursor control or other automated control functions such as navigation in a graphical interface on a display screen, alternatively or in addition to input functions. Control device 716 may be a touchpad, a mouse, a trackball, or cursor direction keys for communicating direction information and command selections to processor 704 and for controlling cursor movement on an output device 712 such as a display. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 714 may include a combination of multiple different input devices, such as a video camera and a depth sensor.

In another embodiment, computer system 700 may comprise an internet of things (IoT) device in which one or more of the output device 712, input device 714, and control device 716 are omitted. Or, in such an embodiment, the input device 714 may comprise one or more cameras, motion detectors, thermometers, microphones, seismic detectors, other sensors or detectors, measurement devices or encoders and the output device 712 may comprise a special-purpose display such as a single-line LED or LCD display, one or more indicators, a display panel, a meter, a valve, a solenoid, an actuator or a servo.

When computer system 700 is a mobile computing device, input device 714 may comprise a global positioning system (GPS) receiver coupled to a GPS module that is capable of triangulating to a plurality of GPS satellites, determining and generating geo-location or position data such as latitude-longitude values for a geophysical location of the computer system 700. Output device 712 may include hardware, software, firmware and interfaces for generating position reporting packets, notifications, pulse or heartbeat signals, or other recurring data transmissions that specify a position of the computer system 700, alone or in combination with other application-specific data, directed toward host computer 724 or server computer 730.

Computer system 700 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 700 in response to processor 704 executing at least one sequence of at least one instruction contained in main memory 706. Such instructions may be read into main memory 706 from another storage medium, such as storage 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 710. Volatile media includes dynamic memory, such as memory 706. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 702. Transmission media can also take the form of acoustic or light waves, such as those generated during radio-wave and infra-red data communications.

Various forms of media may be involved in carrying at least one sequence of at least one instruction to processor 704 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 700 can receive the data on the communication link and convert the data to a format that can be read by computer system 700. For instance, a receiver such as a radio frequency antenna or an infrared detector can receive the data carried in a wireless or optical signal and appropriate circuitry can provide the data to I/O subsystem 702 such as place the data on a bus. I/O subsystem 702 carries the data to memory 706, from which processor 704 retrieves and executes the instructions. The instructions received by memory 706 may optionally be stored on storage 710 either before or after execution by processor 704.

Computer system 700 also includes a communication interface 718 coupled to I/O subsystem 702 or the system bus. Communication interface 718 provides a two-way data communication coupling to network link(s) 720 that are directly or indirectly connected to at least one communication networks, such as a network 722 or a public or private cloud on the Internet. For example, communication interface 718 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 722 broadly represents a local area network (LAN), wide-area network (WAN), campus network, internetwork or any combination thereof. Communication interface 718 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 718 sends and receives electrical, electromagnetic or optical signals over signal paths that carry digital data streams representing various types of information.

Network link 720 typically provides electrical, electromagnetic, or optical data communication directly or through at least one network to other data devices, using, for example, satellite, cellular, Wi-Fi, or BLUETOOTH technology. For example, network link 720 may provide a connection through a network 722 to a host computer 724.

Furthermore, network link 720 may provide a connection through network 722 or to other computing devices via internetworking devices and/or computers that are operated by an Internet Service Provider (ISP) 726. ISP 726 provides data communication services through a world-wide packet data communication network represented as internet 728. A server computer 730 may be coupled to internet 728. Server computer 730 broadly represents any computer, data center, virtual machine or virtual computing instance with or without a hypervisor, or computer executing a containerized program system such as DOCKER or KUBERNETES. Server computer 730 may represent an electronic digital service that is implemented using more than one computer or instance and that is accessed and used by transmitting web services requests, uniform resource locator (URL) strings with parameters in HTTP payloads, API calls, app services calls, or other service calls. Computer system 700 and server computer 730 may form elements of a distributed computing system that includes other computers, a processing cluster, server farm or other organization of computers that cooperate to perform tasks or execute applications or services. Server computer 730 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server computer 730 may comprise a web application server that hosts a presentation layer, application layer and data storage layer such as a relational database system using structured query language (SQL) or no SQL, an object store, a graph database, a flat file system or other data storage.

Computer system 700 can send messages and receive data and instructions, including program code, through the network(s), network link 720 and communication interface 718. In the Internet example, a server computer 730 might transmit a requested code for an application program through Internet 728, ISP 726, local network 722 and communication interface 718. The received code may be executed by processor 704 as it is received, and/or stored in storage 710, or other non-volatile storage for later execution.

The execution of instructions as described in this section may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 704. While each processor 704 or core of the processor executes a single task at a time, computer system 700 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method executed using a first computer and comprising:
transmitting one or more database queries to a database to cause executing searches that return result sets of one or more first calendar events, one or more linked second calendar events that are associated in the database with one or more activities, and one or more user account records that specify associations of user accounts to the one or more activities;
processing one or more of the one or more first calendar events to extract organization-independent features, yielding one or more processed calendar events;
evaluating each of the one or more processed calendar events using a trained machine learning classifier to output a prediction of whether each of the one or more processed calendar events represents an internal event of an entity, and classifying the one or more processed calendar events having prediction values less than a threshold prediction value as activity events;
executing a transformer-based machine learning model to embed the activity events as target vectors and to embed a corpus based on the one or more first calendar events and user account records as candidate vectors;
executing a similarity search of the target vectors against the candidate vectors to output a set of linking candidate vector values that most likely correspond to a particular activity that is represented in the corpus;
ranking the set of linking candidate vector values to form a set of ranked candidate vector values;
transmitting, to a second computer, presentation instructions that are programmed to cause the second computer to display one or more of the activity events that correspond to the set of ranked candidate vector values in a graphical user interface.

2. The computer-implemented method of claim 1, further comprising evaluating each of the one or more processed calendar events using a trained naïve Bayes machine learning classifier to output the prediction of whether each of the one or more processed calendar events represents the internal event of the entity, then performing the classifying the one or more processed calendar events based on the prediction.

3. The computer-implemented method of claim 1, further comprising executing a Sentence-BERT transformer-based machine learning model to embed the activity events as the target vectors and to embed the corpus based on the one or more first calendar events and the user account records as the candidate vectors.

4. The computer-implemented method of claim 1, further comprising executing the similarity search as a nearest neighbor search of the target vectors against the candidate vectors to output the set of linking candidate vector values.

5. The computer-implemented method of claim 1, further comprising ranking the set of linking candidate vector values to form the set of ranked candidate vector values by executing a gradient boosted tree algorithm.

6. The computer-implemented method of claim 1, further comprising evaluating each of the one or more processed calendar events using the trained machine learning classifier, having been trained using a training dataset of other calendar events, the other calendar events that are not linked to the one or more activities having been labeled as internal events, to output a prediction of whether each of the one or more processed calendar events represents an internal event of an entity, and then performing the classifying based on the prediction.

7. The computer-implemented method of claim 1, further comprising receiving, from the second computer, input signaling a selection of a particular activity event from among the one or more of the activity events in the graphical user interface, and in response to the input, creating and storing in the database an association of the particular activity event to the particular activity.

8. The computer-implemented method of claim 1, further comprising:
transmitting, to the second computer, presentation instructions that are programmed to cause the second computer to display an electronic calendar graphical user interface comprising a list of a plurality of the calendar events that are not associated with the one or more activities;
receiving, from the second computer, first input signaling a selection of a particular calendar event in the list of the plurality of the calendar events that are not associated with the one or more activities;
transmitting, to the second computer, presentation instructions that are programmed to cause the second computer to display a graphical panel specifying one or more of the activity events that correspond to the set of the ranked candidate vector values.

9. The computer-implemented method of claim 8, further comprising:
receiving, from the second computer, second input signaling another selection of a particular activity event from among the one or more of the activity events in the graphical panel;
in response to the second input, creating and storing in the database an association of the particular activity event to the particular activity.

10. The computer-implemented method of claim 1, further comprising:
transmitting, to the second computer, presentation instructions that are programmed to cause the second computer to display an electronic calendar graphical user interface comprising at least one first graphical panel associated with a calendar date and a time of day and specifying one the calendar events that is not associated with the one or more activities;
receiving, from the second computer, first input signaling a selection of a particular first graphical panel;
transmitting, to the second computer, presentation instructions that are programmed to cause the second computer to display a second graphical panel specifying one or more of the activity events that correspond to the ranked candidate vector values.

11. The computer-implemented method of claim 10, further comprising:
receiving, from the second computer, second input signaling another selection of a particular activity event from among the one or more of the activity events in the second graphical panel;
in response to the second input, creating and storing in the database an association of the particular activity event to the particular activity.

12. One or more non-transitory computer-readable data storage media storing one or more sequences of instructions which, when executed using one or more processors of a first computer, cause the one or more processors to execute:
transmitting one or more database queries to a database to cause executing searches that return result sets of one or more first calendar events, one or more linked second calendar events that are associated in the database with one or more activities, and one or more user account records that specify associations of user accounts to the one or more activities;
processing one or more of the one or more first calendar events to extract organization-independent features, yielding one or more processed calendar events;
evaluating each of the one or more processed calendar events using a trained machine learning classifier to output a prediction of whether each of the one or more processed calendar events represents an internal event of an entity, and classifying the one or more processed calendar events having prediction values less than a threshold prediction value as activity events;
executing a transformer-based machine learning model to embed the activity events as target vectors and to embed a corpus based on the one or more first calendar events and user account records as candidate vectors;
executing a similarity search of the target vectors against the candidate vectors to output a set of linking candidate vector values that most likely correspond to a particular activity that is represented in the corpus;
ranking the set of linking candidate vector values to form a set of ranked candidate vector values;
transmitting, to a second computer, presentation instructions that are programmed to cause the second computer to display one or more of the activity events that correspond to the set of ranked candidate vector values in a graphical user interface.

13. The one or more non-transitory computer-readable data storage media of claim 12, further comprising sequences of instructions which, when executed using the one or more processors of a first computer, cause the one or more processors to execute evaluating each of the one or more processed calendar events using a trained naïve Bayes machine learning classifier to output the prediction of whether each of the one or more processed calendar events represents the internal event of the entity, then performing the classifying the one or more processed calendar events based on the prediction.

14. The one or more non-transitory computer-readable data storage media of claim 12, further comprising sequences of instructions which, when executed using the one or more processors of a first computer, cause the one or more processors to execute a Sentence-BERT transformer-based machine learning model to embed the activity events as the target vectors and to embed the corpus based on the one or more first calendar events and the user account records as the candidate vectors.

15. The one or more non-transitory computer-readable data storage media of claim 12, further comprising sequences of instructions which, when executed using the one or more processors of a first computer, cause the one or more processors to execute the similarity search as a nearest neighbor search of the target vectors against the candidate vectors to output the set of linking candidate vector values.

16. The one or more non-transitory computer-readable data storage media of claim 12, further comprising sequences of instructions which, when executed using the one or more processors of a first computer, cause the one or more processors to execute ranking the set of linking candidate vector values to form the set of ranked candidate vector values by executing a gradient boosted tree algorithm.

17. The one or more non-transitory computer-readable data storage media of claim 12, further comprising sequences of instructions which, when executed using the one or more processors of a first computer, cause the one or more processors to execute evaluating each of the one or more processed calendar events using the trained machine learning classifier, having been trained using a training dataset of other calendar events, the other calendar events that are not linked to the one or more activities having been labeled as internal events, to output a prediction of whether each of the one or more processed calendar events represents an internal event of an entity, and then performing the classifying based on the prediction.

18. The one or more non-transitory computer-readable data storage media of claim 12, further comprising sequences of instructions which, when executed using the one or more processors of a first computer, cause the one or more processors to execute receiving, from the second computer, input signaling a selection of a particular activity event from among the one or more of the activity events in the graphical user interface, and in response to the input, creating and storing in the database an association of the particular activity event to the particular activity.

19. The one or more non-transitory computer-readable data storage media of claim 12, further comprising sequences of instructions which, when executed using the one or more processors of a first computer, cause the one or more processors to execute:
transmitting, to the second computer, presentation instructions that are programmed to cause the second computer to display an electronic calendar graphical user interface comprising a list of a plurality of the calendar events that are not associated with the one or more activities;
receiving, from the second computer, first input signaling a selection of a particular calendar event in the list of the plurality of the calendar events that are not associated with the one or more activities;
transmitting, to the second computer, presentation instructions that are programmed to cause the second computer to display a graphical panel specifying one or more of the activity events that correspond to the set of the ranked candidate vector values.

20. The one or more non-transitory computer-readable data storage media of claim 19, further comprising sequences of instructions which, when executed using the one or more processors of a first computer, cause the one or more processors to execute:
receiving, from the second computer, second input signaling another selection of a particular activity event from among the one or more of the activity events in the graphical panel;
in response to the second input, creating and storing in the database an association of the particular activity event to the particular activity.

21. The one or more non-transitory computer-readable data storage media of claim 12, further comprising sequences of instructions which, when executed using the one or more processors of a first computer, cause the one or more processors to execute:
transmitting, to the second computer, presentation instructions that are programmed to cause the second computer to display an electronic calendar graphical user interface comprising at least one first graphical panel associated with a calendar date and a time of day and specifying one the calendar events that is not associated with the one or more activities;
receiving, from the second computer, first input signaling a selection of a particular first graphical panel;
transmitting, to the second computer, presentation instructions that are programmed to cause the second computer to display a second graphical panel specifying one or more of the activity events that correspond to the ranked candidate vector values.

22. The one or more non-transitory computer-readable data storage media of claim 21, further comprising sequences of instructions which, when executed using the one or more processors of a first computer, cause the one or more processors to execute:
receiving, from the second computer, second input signaling another selection of a particular activity event from among the one or more of the activity events in the second graphical panel;
in response to the second input, creating and storing in the database an association of the particular activity event to the particular activity.
